(19) United States
(12) Patent Application Publication
(10) Pub. No.: US 2007/0167596 A1
(43) Pub. Date: Jul. 19, 2007

(54) Method of making branched polysilanes

(76) Inventors: Travis Hein, Bay City, MI (US); Russell Keith King, Midland, MI (US); Binh Thanh Nguyen, Midland, MI (US); Herschel Henry Reese, Midland, MI (US); Michael Andrew Smith, Midland, MI (US); Hanh Xuan Vo, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 11/578,630

(22) PCT Filed: May 10, 2005
(86) PCT No.: PCT/US05/16362

§ 371 Date: Oct. 17, 2006

Related U.S. Application Data
(60) Provisional application No. 60/571,184, filed on May 14, 2004.

(51) Int. Cl. C08G 77/00

(52) U.S. Cl. 528/10; 528/31

(57) ABSTRACT

In a first method, branched polysilanes are prepared via a Wurtz-type coupling reaction by reacting a mixture of a dihalosilanes and a trihalosilanes with an alkali metal coupling agent in an organic liquid medium. The reaction mixture is free of tetrahalosilanes. The branched polysilanes are recovered from the reaction mixture. In a second method, capped-branched polysilanes are prepared via the same Wurtz-type coupling reaction noted above, with the addition of a capping agent to the reaction mixture. The capping agent can be a monohalosilane, monoalkoxysilane, or trialkoxysilane. Capped-branched polysilanes are re-covered from the reaction mixture. The branched polysilanes are soluble in organic liquid mediums.

### CROSS REFERENCE TO RELATED APPLICATIONS

Not applicable.

### FIELD OF THE INVENTION

This invention is related to a method of making branched polysilanes, in particular to a Wurtz-type coupling reaction of dihalosilanes and trihalosilanes. The improvement according to the method of the invention is that it produces branched polysilanes rather than linear polysilanes. The branched polysilanes are soluble in organic liquid mediums.

### BACKGROUND OF THE INVENTION

The earliest synthetic procedure for the preparation of polysilanes utilized the Wurtz-type reductive coupling of dichlorosilanes. Polysilanes can be prepared by other synthetic routes. For example, polysilanes have been prepared by (i) the dehydrocoupling of monosubstituted silanes using a transition metal catalyst, (ii) the ring opening polymerization of cyclosiloxanes, (iii) anionic polymerization of masked silanes, and (iv) the sonochemical coupling of dichlorosilanes with an alkali metal. However, in spite of efforts to displace it, the Wurtz reductive-coupling of dichlorosilanes to make polysilanes remains the most common and generally accepted procedure for the synthesis of polysilanes. Although the synthesis of polysilanes by the reductive coupling of dichlorosilanes with an alkali metal such as sodium in a solvent such as toluene at 100° C. possesses poor reproducibility and low yields, Wurtz-type coupling still remains the overall the most effective procedure for making polysilanes. Yet, it still remains very difficult and challenging to reproduce preparation methods for polysilanes, since the development of chemical processes for manufacturing polysilanes is complicated and fraught with difficulty.

For example, a method of preparing a branched polysilane by reacting a dihalosilane and a trihalosilane is described in United States Patent Application Publication No. US 2002/0177660 (Nov. 28, 2002). However, the method according to the '660 publication requires the presence of a tetrahalosilane, in addition to a dihalosilane and a trihalosilane. In contrast to the method in the '660 publication, the method according to this invention is more efficient in that it is capable of preparing branched polysilanes by reacting only dihalosilanes and trihalosilanes as starting materials, with the result that it is free of the complications inherent in processes containing tetrahalosilanes.

### SUMMARY OF THE INVENTION

The invention is directed to a first method of preparing branched polysilanes by a Wurtz-type coupling reaction by reacting a mixture of a dihalosilane and a trihalosilane with an alkali metal coupling agent in an organic liquid medium. The reaction mixture is free of tetrahalosilanes, and branched polysilanes are recovered from the reaction mixture. The branched polysilane according to this first embodiment of the invention has the formula:

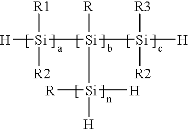

In the formula, R, R1, R2, and R3 are alkyl groups, aryl groups, cycloalkyl groups, aralkyl groups, or alkaryl groups; and the values of a, b, c, and n, are such as to provide a branched polysilane having a molecular weight in the range of 10,000-50,000.

The invention is also directed to a second method of preparing branched polysilanes by a Wurtz-type coupling reaction by reacting a mixture of a dihalosilane and a trihalosilane with an alkali metal coupling agent in an organic liquid medium. The reaction mixture is free of tetrahalosilanes. A capping agent is added to the reaction mixture, and capped branched polysilanes are recovered from the reaction mixture. The capping agent can be a monohalosilane, monoalkoxysilane, dialkoxysilane, or trialkoxysilane. The capped branched polysilane according to this second embodiment of the invention has the formula:

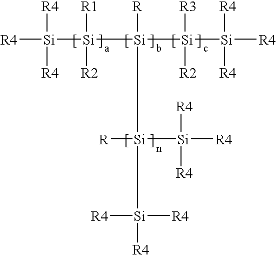

In this formula, R, R1, R2, and R3 are alkyl groups, aryl groups, cycloalkyl groups, aralkyl groups, or alkaryl groups; R4 is an alkyl group, an aryl group, a cycloalkyl group, an aralkyl group, an alkaryl group, or an alkoxy group; and the values of a, b, c, and n, are such as to provide a capped branched polysilane having a molecular weight in the range of 10,000-50,000.

In the preferred embodiments, the organic liquid medium is one in which the branched polysilane is soluble, most preferably the organic liquid is toluene; the alkali metal coupling agent is sodium; and the reaction is carried out at a temperature in the range of 50-200° C. Preferably the temperature is in the range of 110-115° C., which is close to the melting temperature of sodium, offering some advantage in manufacturing in terms of dispersion of the sodium.

These and other features of the invention will become apparent from a consideration of the detailed description.

### BRIEF DESCRIPTION OF THE DRAWING

Not applicable.

### DETAILED DESCRIPTION OF THE INVENTION

The most common method used for the synthesis of polysilanes is the Wurtz-type coupling of dihalosilanes which is shown below.

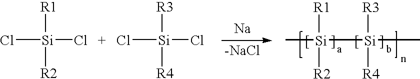

This sodium coupling reaction is typically carried out in a refluxing hydrocarbon such as toluene. It produces a mixture of linear polysilanes, oligomeric polysilanes, and cyclic polysilanes, with the yield of linear polysilanes being in low to moderate ranges.

In contrast to the above, the method according to the present invention involves a Wurtz-type coupling of dihalosilanes and trihalosilanes, rather than a Wurtz-type coupling of dihalosilanes as shown above. The improvement according to the invention produces branched polysilanes rather than linear polysilanes. The method according to the present invention is shown below.

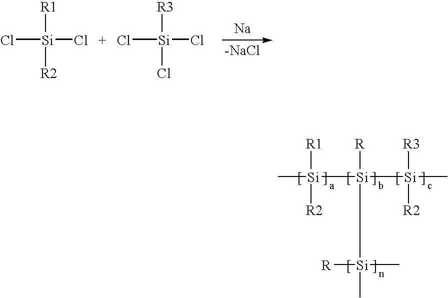

In the above illustration of the improved method according to the invention, the end groups on the branched polysilane are not shown, since they depend upon what additional steps are carried out at the end of the reaction of the dihalosilanes and trihalosilanes, i.e., no capping versus capping. The values of the integers represented by a, b, c, and n, are each such as to provide a branched polysilane having a molecular weight in the range of 10,000-50,000.

When the branched polysilane of the invention is not capped, it has a structure generally corresponding to the structure:

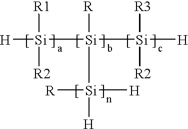

In this structure, R, R1, R2, and R3 each represents an alkyl group, an aryl group, a cycloalkyl group, an aralkyl group, or an alkaryl group. The values of a, b, c, and n, are such as to provide a branched polysilane having a molecular weight in the range of 10,000-50,000.

When the branched polysilane of the invention is capped, however, it has a structure generally corresponding to the structure:

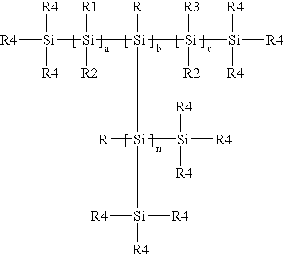

In this structure, the R, R1, R2, and R3 groups in the capped branched polysilane structure are the same as noted above; whereas the R4 group represents an alkyl group, an aryl group, a cycloalkyl group, an aralkyl group, an alkaryl group, or an alkoxy group. As previously indicated, the values of the integers represented by a, b, c, and n, are each such as to provide branched polysilanes having a molecular weight in the range of 10,000-50,000. Representative capping agents that can be used according to the method of the invention include monohalosilanes, monoalkoxysilanes, dialkoxysilanes, and trialkoxysilanes.

Illustrative of R, R1, R2, R3, and R4 groups that can be present in the branched polysilanes of the invention include alkyl groups such as the methyl, ethyl, propyl, isopropyl, butyl, amyl, hexyl, octyl, decyl, dodecyl, octadecyl, and myricyl groups; cycloalkyl groups such as the cyclobutyl and cyclohexyl groups; aryl groups such as the phenyl, xenyl, and naphthyl groups; aralkyl groups such as the benzyl and 2-phenylethyl groups; alkaryl groups such as the tolyl, xylyl and mesityl groups; and alkoxy groups such as the methoxy, ethoxy, propoxy, and butoxy groups. It is preferred that the R, R1, R2, R3 groups be a hydrocarbon group containing from 1-18 carbon atoms. Especially preferred R, R1, R2, and R3 groups are methyl and phenyl, accordingly.

Some examples of monohalosilanes that can be used include benzyldimethylchlorosilane, n-butyldimethylchlorosilane, tri-n-butylchlorosilane, ethyldimethylchlorosilane, triethylchlorosilane, trimethylchlorosilane, n-octadecyldimethylchlorosilane, phenyldimethylchlorosilane, triphenylchlorosilane, cyclohexyldimethylchlorosilane, cyclopentyldimethylchlorosilane, n-propyldimethylchlorosilane, and tolyldimethylchlorosilane.

Some examples of dihalosilanes that can be used include t-butylphenyldichlorosilane, dicyclohexyldichlorosilane, diethyldichlorosilane, dimethyldichlorosilane, diphenyldichlorosilane, hexylmethyldichlorosilane, phenylethyldichlorosilane, phenylmethyldichlorosilane, (3-phenylpropyl)methyldichlorosilane, diisopropyldichlorosilane, (4-phenylbutyl)methyldichlorosilane, and n-propylmethyldichlorosilane.

Some examples of trihalosilanes that can be used include benzyltrichlorosilane, n-butyltrichlorosilane, cyclohexyltrichlorosilane, n-decyltrichlorosilane, dodecyltrichlorosilane, ethyltrichlorosilane, n-heptyltrichlorosilane, methyltrichlorosilane, n-octyltrichlorosilane, pentyltrichlorosilane, and phenyltrichlorosilane.

Some examples of monoalkoxysilanes that can be used include t-butyldiphenylmethoxysilane, trimethylethoxysilane, trimethylmethoxysilane, trimethyl-n-propoxysilane, n-octadecyldimethylmethoxysilane, octyldimethylmethoxysilane, cyclopentyldiethylmethoxysilane, dicyclopentylmethylmethoxysilane, tricyclopentylmethoxysilane, phenyldimethylethoxysilane, diphenylmethylethoxysilane, and triphenylethoxysilane.

Some examples of dialkoxysilanes that can be used include dibutyldimethoxysilane, dodecylmethyldiethoxysilane, diethyldiethoxysilane, dimethyldimethoxysilane, dimethyldiethoxysilane, n-octylmethyldiethoxysilane, octadecylmethyldimethoxysilane, diphenyldiethoxysilane, diphenyldimethoxysilane, phenylmethyldiethoxysilane, phenylmethyldimethoxysilane, and diphenyldimethoxysilane.

Some examples of trialkoxysilanes that can be used include benzyltriethoxysilane, cyclohexyltrimethoxysilane, n-decyltriethoxysilane, dodecyltriethoxysilane, ethyltriethoxysilane, hexadecyltriethoxysilane, methyltriethoxysilane, octyltriethoxysilane, phenyltriethoxysilane, phenyltrimethoxysilane, and n-propyltrimethoxysilane.

The various silanes used are present in reactions according to the methods of the invention in the stoichiometric proportions necessary to carry out the reactions and bring the reactions to completion.

The alkali metal coupling agent used in the process of the invention can be sodium, potassium, or lithium. Sodium is preferred as it provides the highest yield of branched polysilanes. The amount of alkali metal used in the reaction is at least three moles per mole of the silanes utilized. In order to ensure completion of the reaction, it is preferred to add an amount slightly in excess of three moles of the alkali metal per mole of silanes.

The process of the invention can be facilitated by addition of an acid such as acetic acid. The function of acetic acid, for example, is to neutralize the sodium metal to sodium acetate, i.e., Na+CH₃COOH→CH₃COONa, which is a salt, and it can be removed together with the NaCl salt. In addition to acetic acid, other organic acids can be used such as citric acid and benzoic acid, as well as inorganic acids such as HCl, nitric acid, and sulphuric acid; including combinations of organic acids and inorganic acids.

The organic liquid medium in which the reaction takes place may be any solvent in which the dihalosilane and trihalosilane reactants are soluble. Preferably, the solvent used is one in which the branched polysilane which is produced in the process is also soluble. These solvents include hydrocarbon solvents such as toluene; paraffins; ethers; and nitrogen containing solvents such as triethylamine, N,N,N′,N′-tetramethylethylenediamine, and cyclohexylamine. The organic liquid medium can be a mixture of solvents such as a hydrocarbon solvent and an ether, one example of which is toluene and anisole. Preferably, toluene is used as the organic liquid medium. The organic liquid medium is not generally a solvent for the alkali metal halides that are formed, and these can be easily removed by filtration. The amount of organic liquid medium used in the process of the invention is not critical, although the use of progressively larger amounts can result in branched polysilanes of progressively lower molecular weight.

The process may be carried out at any temperature, but preferably the reaction temperature is in the range of 50-200° C., preferably 110-115° C. The reaction that occurs is exothermic, and is preferably initiated at room temperature. No external heat is supplied during the reaction. If the temperature is increased, an increase in the molecular weight of the formed branched polysilanes is usually observed. This may lead to the production of branched polysilanes that are insoluble in the organic liquid medium.

The reproducibility of the process is determined by the reproducibility of local mass and heat transfer operations. Since the intrinsic reaction kinetics are very fast, the overall process has to be controlled by mass and heat transfer. In this regard, mass/heat transfer can be controlled by (i) maintaining the power/volume above the level necessary for suspending the sodium droplets or particles, (ii) adding the reactants sub-surface wise into well-mixed zones, and (ii) precisely controlling the rate of addition rate. For instance, the rate of addition of the chlorosilanes is an important factor in controlling the molecular weight distribution.

When the reaction has proceeded to the desired degree, the branched polysilane may be recovered from the reaction mixture by any suitable method. If the branched polysilane is insoluble in the liquid organic material in which the reaction took place, it can be filtered out from the mixture. This is preferably done when other insolubles, such as the alkali metal halides that are formed as a side product, have been removed by scooping or decanting. Depending on the components of the reaction, the solid byproduct may float towards the surface of the mixture, while the branched polysilane tends to precipitate. If the branched polysilane is soluble in the solvent, other insolubles can be removed by filtration, the branched polysilane can be retained in the solvent, purified by washing, or dried to a powder.

### EXAMPLES

The following examples are set forth in order to illustrate the invention in more detail.

### Example 1

### PhMeSiCl₂ with 15 Percent MeSiCl₃ and No Capping Agent

Toluene (1540 gram) and sodium metal (55.7 gram) were loaded into a cylindrical, glass, 2-liter vessel, and then the toluene was brought to reflux with a recirculating bath through the jacket. An argon atmosphere with a slight positive pressure was maintained throughout the process. A dual pitched-blade impeller was used to disperse the molten sodium, and the jacket temperature was maintained at 110° C. A mixture of phenylmethyldichlorosilane (169.4 gram) and methyltrichlorosilane (23.4 gram) was introduced to the reactor over a period of thirty minutes using a dip tube positioned above the top of the impeller. This resulted in an exotherm to 113° C. After holding the reactor temperature for two hours, the contents were cooled to 90° C. before being transferred to a 12-liter round-bottom flask. Methanol was added slowly to oxidize the residual sodium, and more methanol was added to a total of 5200 gram to precipitate the product. The methanol layer was removed from the flask, and replaced with 2000 gram of toluene to re-dissolve the product. This slurry was centrifuged to separate the salt. The toluene solution was filtered, and then concentrated to 300 gram by rotary evaporation. This solution was added slowly to 2150 gram of methanol to re-precipitate the product, which was then filtered, and dried in a vacuum oven. The yield was 44.3 gram of a powdery white solid. Gel permeation chromatography indicated a molecular (Mw) of 24,900 with a polydispersity of 7.2.

### Example 2

### PhMeSiCi₂ with 20 Percent MeSiCl₃ and No Capping Agent

Toluene (1350 gram) and sodium metal (85.05 gram) were loaded into a cylindrical, glass, 2-liter vessel, and then the toluene was brought to reflux using a recirculating bath through the jacket. An argon atmosphere with a slight positive pressure was maintained throughout the process. A dual pitched-blade impeller was used to disperse the molten sodium, and the jacket temperature was maintained at 110° C. A mixture of phenylmethyldichlorosilane (247.21 gram) and methyltrichlorosilane (48.33 gram) was introduced into the reactor over thirty minutes by means of a dip tube positioned above the top of the impeller, resulting in an exotherm to 113° C. After maintaining the reactor temperature for one hour, the contents were cooled to 90° C. before being transferred to a 12-liter round-bottom flask. Methanol was added slowly to oxidize the residual sodium, and then more methanol was added to a total of 2326 gram to precipitate the product. The methanol layer was removed from the flask and replaced with 3000 gram of toluene to re-dissolve the product. This slurry was centrifuged to separate the salt. The toluene solution was filtered and concentrated to 453.74 gram by rotary evaporation. The solution was added slowly to 3296 gram of methanol to re-precipitate the product, which was then filtered, and dried in a vacuum oven. The yield was 89.1 gram of a powdery white solid.

### Example 3

### PhMeSiCl₂ with 20 Percent MeSiCi₃ and PhMe₂SiCl as Capping Agent

Toluene (1350 gram) and sodium metal (85.05 gram) were loaded into a cylindrical, glass, 2-liter vessel, and then the toluene was brought to reflux using a recirculating bath through the jacket. An argon atmosphere with a slight positive pressure was maintained throughout the process. A dual pitched-blade impeller was used to disperse the molten sodium, and the jacket temperature was maintained at 110° C. A mixture of phenylmethyldichlorosilane (247.21 gram) and methyltrichlorosilane (48.33 gram) was introduced to the reactor over thirty minutes by means of a dip tube positioned above the top of the impeller, resulting in an exotherm to 113° C. After maintaining the reactor temperature for 30 minutes, 58.59 g of PhMe₂SiCl was added quickly, followed by a 10 milliliter toluene flush. One hour after the initial feed had been completed, the contents were cooled to 90° C. before being transferred to a 12-liter round-bottom flask. Methanol was added slowly to oxidize the residual sodium, and more methanol was added to a total of 2326 gram to precipitate the product. The methanol layer was removed from the flask and replaced with 3000 gram of toluene to re-dissolve the product. The resulting slurry was centrifuged to separate the salt. The toluene solution was filtered and concentrated to 396.5 gram by rotary evaporation. The solution was added slowly to 3297 gram of methanol to re-precipitate the product, which was filtered and dried in a vacuum oven. The yield was 81.42 gram of a powdery white solid.

### Example 4

### PhMeSiCl₂ with 10 Percent MeSiCl₃ and 5 Percent PhMeSiCl₃ and No PhMe₂SiCl as Capping Agent

Toluene (4025.0 gram) and sodium metal (167.92 gram) were loaded into a cylindrical, glass, 6-liter vessel, and then the toluene was brought to reflux using a recirculating bath through the jacket. An argon atmosphere with a slight positive pressure was maintained throughout the process. A dual pitched-blade impeller was used to disperse the molten sodium, and the jacket temperature was maintained at 110° C. A mixture of phenylmethyldichlorosilane (508.77 gram), methyltrichlorosilane (46.82 gram), and phenyltrichlorosilane (33.13 gram) was introduced to the reactor over 60 minutes by means of a dip tube positioned above the top of the impeller, resulting in an exotherm to 113° C. After maintaining the reactor temperature for two hours, the contents were cooled to 40° C. Methanol (465.99 gram) was added slowly to oxidize the residual sodium. The mixture was held for 30 minutes before being drained from the reactor into 500 milliliter bottles. This slurry was centrifuged and filtered through a Seitz KS depth filter to separate the salt. The solution was concentrated using a stripper to 1642.5 gram, which provided a solution containing about 17 percent by weight of solids in toluene. The solution was filtered through a Seitz EK depth filter and added slowly to 9020 gram of methanol. This provided a 7:1 methanol to toluene ratio to re-precipitate the product. The solution was filtered and dried in a vacuum oven. The yield was 240.6 gram of a powdery white solid. The powder was dissolved in toluene (441.8 gram) to make a solution containing 35 percent by weight of solids. The solution was filtered through a Seitz EK type depth filter and yielded 603 gram of a very clear solution. The solution was added slowly to 2743.7 gram of methanol to precipitate out the polymer. Again, this provided a solution with a 7:1 methanol to toluene ratio. This slurry was filtered and dried in a vacuum oven. The yield was 198.6 gram of a powdery white solid, i.e., a yield of 56.7 percent by weight. Gel permeation chromatography indicated a molecular weight of 27,000. The percent Transmittance of a 50 percent by weight solution of the product in anisole was 95.5 percent initially and 89.5 percent after 3 weeks aging.

### Example 5

### PhMeSiCl₂ with 10 Percent MeSiCl₃ and 5 Percent PhMeSiCl₃ and PhMe₂SiCl as Capping Agent

Toluene (4025.0 gram) and sodium metal (167.24 gram) were loaded into a cylindrical, glass, 6-liter vessel, and then the toluene was brought to reflux using a recirculating bath through the jacket. An argon atmosphere with a slight positive pressure was maintained throughout the process. A dual pitched-blade impeller was used to disperse the molten sodium, and the jacket temperature was maintained at 110° C. A mixture of phenyl methyl dichlorosilane (508.78 gram), methyltrichlorosilane (46.81 gram), and phenyltrichlorosilane (33.14 gram) was introduced into the reactor over 60 minutes using a dip tube positioned above the top of the impeller, resulting in an exotherm to 113° C. After maintaining the reactor temperature for 30 minutes, phenyldimethylchlorosilane (126.04 gram) was added quickly. After maintaining the reactor temperature for an additional 1.5 hours, the contents were cooled to 40° C. Methanol (465.99 gram) was added slowly to oxidize the residual sodium. The mixture was maintained for 30 minutes before being drained from the reactor into 500 milliliter bottles. The resulting slurry was centrifuged and filtered through a Seitz KS depth filter to separate the salt. The solution was concentrated to 1737.5 gram using a stripper, and provided a solution containing about 17 percent by weight of solids in toluene. This solution was filtered through a Seitz EK depth filter and added slowly to 9300 gram of methanol. The solution contained a 7:1 methanol to toluene ratio to re-precipitate the product. The solution was filtered and dried in a vacuum oven. The yield was 279.5 gram of a powdery white solid. The powder was dissolved in toluene (508.9 gram) resulting in a solution containing 35 percent by weight of the powder. The solution was filtered through a Seitz EK type depth filter and yielded 698.3 gram of a very clear solution. The solution was added slowly to 3200 gram of methanol to precipitate out the polymer. The solution contained a 7:1 methanol to toluene ratio. The product was filtered and dried in a vacuum oven. The yield was 225.5 gram of a powdery white solid, i.e., a yield of 64.4 percent by weight. Gel permeation chromatography indicated a molecular weight of 24,100. The percent Transmittance of a 50 percent by weight solution of the product in anisole was 96.5 percent initially and 95.5 percent after 3 weeks aging.

### Example 6

### PhMeSiCl₂ with 15 Percent MeSiCi₃ and No Capping Agent

Toluene (1461.43 gram) and sodium metal (54.04 gram) were loaded into a cylindrical, glass, 2-liter vessel, and then the toluene was brought to reflux using a recirculating bath through the jacket. An argon atmosphere with a slight positive pressure was maintained throughout the process. A dual pitched-blade impeller was used to disperse the molten sodium, and the jacket temperature was maintained at 110° C. A mixture of phenylmethyldichlorosilane (164.47 gram) and methyltrichlorosilane (22.72 gram) was introduced into the reactor over 60 minutes using a dip tube positioned above the top of the impeller, resulting in an exotherm to 113° C. After maintaining the reactor temperature for 120 minutes, the contents were cooled to 40° C. Methanol (150.64 gram) was added slowly to oxidize the residual sodium. The mixture was held for 30 minutes. The temperature was raised to 50° C., and a vacuum was established to remove the residual methanol from the mixture. The mixture was drained from the reactor into 500 milliliter bottles. This slurry was filtered through a Seitz KS depth filter to remove the salt. The solution was concentrated to 313 gram using a stripper, and provided a solution containing about 17 percent by weight of solids in toluene. The solution was filtered through a Seitz EK depth filter and added slowly to 9300 gram of methanol. The solution contained a 7:1 methanol to toluene ratio to re-precipitate the product. The solution was filtered through a No. 3 Whatman paper filter. The wet powder was placed in toluene (118.9 gram) to make a 35 percent by weight solution. The solution was filtered through a Seitz EK type depth filter, yielding 157.7 gram of a cloudy solution. The solution was added slowly to 717.5 gram of methanol to precipitate out the polymer. The solution contained a 7:1 methanol to toluene ratio. The solution was filtered and dried in a vacuum oven. The yield was 25.8 gram of a powdery white solid, i.e., a yield of 23.5 percent by weight. Gel permeation chromatography indicated a molecular weight of 23,600. The percent Transmittance of a 50 percent by weight solution of the product in anisole was 96.5 percent initially and 95.5 percent after 3 weeks aging.

### Example 7

### PhMeSiCl₂ with 15 Percent MeSiCl₃ and Me₃SiCl as Capping Agent

Toluene (4025.0 gram) and sodium metal (172.06 gram) were loaded into a cylindrical, glass, 6-liter vessel, and then the toluene was brought to reflux using a recirculating bath through the jacket. A nitrogen atmosphere with a slight positive pressure was maintained throughout the process. A dual pitched-blade impeller was used to disperse the molten sodium, and the jacket temperature was maintained at 110° C. A mixture of phenylmethyldichlorosilane (523.32 gram) and methyltrichlorosilane (72.22 gram) was introduced to the reactor over 60 minutes using a dip tube that was positioned above the top of the impeller, resulting in an exotherm to 113° C. After maintaining the reactor temperature for 30 minutes, trimethylchlorosilane (113.53 gram) was added quickly. After maintaining the reactor temperature for an additional 1.5 hours, the contents was cooled to 40° C. Methanol (479.30 grain) was added slowly to oxidize the residual sodium. The mixture was held for 30 minutes before being drained from the reactor into 500 milliliter bottles. This slurry was centrifuged and filtered through a Seitz KS depth filter to separate the salt. The solution was concentrated to 1448 gram using a stripper providing a solution containing about 17 percent by weight of solids in toluene. The solution was filtered through a Seitz EK depth filter, and 1062.7 gram of the solution were added slowly to 6174 gram of methanol. The solution contained a 7:1 methanol to toluene ratio to re-precipitate the product. The solution was filtered and dried in a vacuum oven, yielding 106.4 gram of a powdery white solid. The powder was dissolved in toluene to make a 35 percent by weight solution. The solution was filtered through a Seitz EK type depth filter, yielding 266.7 gram of a hazy solution. The solution was added slowly to 1213 gram of methanol to precipitate out the polymer. The resulting solution contained a 7:1 methanol to toluene ratio. The solution was filtered and dried in a vacuum oven. The yield was 88.76 gram of a powdery white solid, i.e., a yield of 25.4 percent by weight. Gel permeation chromatography indicated a molecular weight of 18,500. The percent Transmittance of a 50 percent by weight solution of the product in anisole was 95.2 percent initially and 95.0 percent after 3 weeks aging.

### Example 8

### PhMeSiCl₂ with 15 Percent MeSiCl₃ and Acetic Acid—No Capping Agent

Toluene (4019.0 gram) and sodium metal (167.04 gram) were loaded into a cylindrical, glass, 6-liter vessel, and then the toluene was brought to reflux using a recirculating bath through the jacket. A nitrogen atmosphere with a slight positive pressure was maintained throughout the process. A dual pitched-blade impeller was used to disperse the molten sodium, and the jacket temperature was maintained at 110° C. A mixture of phenylmethyldichlorosilane (508.35 gram) and methyltrichlorosilane (70.17 gram) was introduced into the reactor over 60 minutes using a dip tube positioned above the top of the impeller, resulting in an exotherm to 113° C. After maintaining the reactor temperature for two hours, the contents were cooled to 40° C. A mixture of methanol (465.99 gram) and acetic acid (32.31 gram) was added slowly to oxidize the residual sodium. The mixture was held for 30 minutes before being drained from the reactor into 500 milliliter bottles. This slurry was centrifuged and filtered through a Seitz KS depth filter to separate the salt. The solution was concentrated to 1509.7 gram using a stripper, which provided a concentration of solids in toluene of about 17 percent by weight. The solution was filtered through a Seitz EK depth filter leaving 1076 gram of solution, which was added slowly to 6252 gram of methanol. The solution contained a 7:1 methanol to toluene ratio to re-precipitate the product. The solution was filtered and dried in a vacuum oven. The yield was 97.75 gram of a powdery white solid. The powder was dissolved in toluene (182 gram) to make a 35 percent by weight solution. The solution was filtered through a Seitz EK type depth filter yielding 234.4 gram of a clear solution. The solution was added slowly to 1065 gram of methanol to precipitate out the polymer. The solution contained a 7:1 methanol to toluene ratio. The solution was filtered and dried in a vacuum oven. The yield was 80.4 gram of a powdery white solid, i.e., a yield of 23.6 percent by weight. Gel permeation chromatography indicated a molecular weight of 15,800. The percent Transmittance of a solution containing 50 percent by weight of the product in anisole was 96.4 percent initially and 96.3 percent after 3 weeks aging.

### Example 9

### PhMeSiCl₂ with 15 Percent MeSiCl₃ and MeSi(OMe)₃ as Capping Agent

Toluene (4025.0 gram) and sodium metal (172.33 gram) were loaded into a cylindrical, glass, 6-liter vessel, and then the toluene was brought to reflux using a recirculating bath through the jacket. A nitrogen atmosphere with a slight positive pressure was maintained throughout the process. A dual pitched-blade impeller was used to disperse the molten sodium, and the jacket temperature was maintained at 110° C. A mixture of phenylmethyldichlorosilane (523.32 gram) and methyltrichlorosilane (72.24 gram) was introduced into the reactor over 60 minutes using a dip tube positioned above the top of the impeller, resulting in an exotherm to 113° C. After maintaining the reactor temperature for 30 minutes, methyltrimethoxysilane (103.5 gram) was added quickly. After maintaining the reactor temperature for an additional 1.5 hours, the contents was cooled to 40° C. Methanol (479.30 gram) was added slowly to oxidize the residual sodium. The mixture was held for 30 minutes before being drained from the reactor into 500 milliliter bottles. This slurry was centrifuged and filtered through a Seitz KS depth filter to separate the salt. The solution was concentrated using a stripper to 1387 gram. The solution contained 17 percent by weight of solids in toluene. The solution was filtered through a Seitz EK depth filter, and 1153.9 gram of the solution were added slowly to 6704 gram of methanol. The solution contained a 7:1 methanol to toluene ratio to re-precipitate the product. The solution was filtered and dried in a vacuum oven, yielding 95.6 gram of a powdery white solid. The powder was dissolved in toluene (176 gram) to make a solution containing 35 percent by weight of the solid. The solution was filtered through a Seitz EK type depth filter, yielding 191.6 gram of a clear solution. The solution was added slowly to 872 gram of methanol to precipitate out the polymer. The solution contained a 7:1 methanol to toluene ratio. The solution was filtered and dried in a vacuum oven. The yield was 63.2 gram of a powdery white solid, i.e., a yield of 18.0 percent by weight. Gel permeation chromatography indicated a molecular weight of 15,800. The percent Transmittance of a solution containing 50 percent by weight of solids in anisole was 89.9 percent initially.

The following additional examples are set forth to demonstrate the reproducibility of the method according to the present invention, as well as its capability in enabling one skilled in the art to control the molecular weight of the branched polysilanes. In particular, Examples 10 and 11 demonstrate the high reproducibility of the method, as well as Examples 12 and 13. The control of molecular weigh, on the other hand, is demonstrated by comparing Examples 5, 16, and 17. Another feature illustrated in Example 16 is the use of Ph₂MeSiCl as the capping agent, instead of PhMe₂SiCl, since Ph₂MeSiCl is a less expensive commodity than PhMe₂SiCl.

### Example 10

### PhMeSiCl₂ with 20% MeSiCl₃, No Capping Agent and 30 Minute Addition Time

Toluene (1039.34 gram) and sodium metal (58.92 gram) were loaded into a cylindrical, glass, 2-liter vessel, and then the toluene was brought to reflux using a recirculating bath through the jacket. An argon atmosphere with a slight positive pressure was maintained throughout the process. A dual pitched-blade impeller was used to disperse the molten sodium, and the jacket temperature was maintained at 110° C. A mixture of phenyl methyl dichlorosilane (164.8 gram), methyl trichlorosilane (32.22 gram), and toluene (500 g) was then introduced to the reactor over a period of thirty minutes using a dip tube positioned above the top of the impeller. This resulted in an exotherm to 113° C. After maintaining the reactor temperature for one hour, its contents were cooled to 90° C. before it was transferred to a 12-liter round-bottom flask. Methanol was added slowly to oxidize the residual sodium, and more methanol was added to a total of 5186.95 gram to precipitate the product. The methanol layer was removed from the flask by vacuum, and it was replaced with 2000 gram of toluene to re-dissolve the product. This slurry was then centrifuged to separate the salt. The toluene solution was filtered, and then concentrated to 331 gram by rotary evaporation. This solution was added slowly to 2200 gram of methanol to re-precipitate the product, which was then filtered and dried in a vacuum oven, yielding 46.11 g of a powdery white solid. Gel permeation chromatography indicated a Mw of 43,800.

### Example 11

### Example 10 Repeated—PhMeSiCl2 with 20% MeSiCi3 and No Capping Agent

Gel permeation chromatography indicated a Mw of 144,200.

### Example 12

### PhMeSiCl₂ with 20% MeSiCi₃ and No Capping Agent—30 Minute Addition Time and a Holding Time of 120 Minutes

Toluene (1539.34 gram) and sodium metal (58.88 gram) were loaded into a cylindrical, glass, 2-liter vessel, and then the toluene was brought to reflux using a recirculating bath through the jacket. An argon atmosphere with a slight positive pressure was maintained throughout the process. A dual pitched-blade impeller was used to disperse the molten sodium, and the jacket temperature was maintained at 110° C. A mixture of phenyl methyl dichlorosilane (164.8 gram) and methyl trichlorosilane (32.22 gram) was introduced to the reactor over a period of thirty minutes using a dip tube positioned above the top of the impeller. This resulted in an exotherm to 113° C. After maintaining the reactor temperature for one hour, its contents were cooled to 90° C. before being transferred to a 12-liter round-bottom flask. Methanol was added slowly to oxidize the residual sodium, and then more methanol was added to a total of 5184.95 gram to precipitate the product. The methanol layer was removed from the flask by vacuum and replaced with 2000 gram of toluene to re-dissolve the product. This slurry was centrifuged to separate the salt. The toluene solution was filtered, and then concentrated to 287.9 gram by rotary evaporation. This solution was added slowly to 2197.4 g of methanol to re-precipitate the product. The solution was filtered and dried in a vacuum oven, yielding 40.63 g of a powdery white solid. Gel permeation chromatography indicated a Mw of 25,000.

### Example 13

### Example 12 Repeated—PhMeSiCl₂ with 20% MeSiCi₃ and No Capping Agent

Gel permeation chromatography indicated a Mw of 25,400.

### Example 14

### Similar to Example 5 except that the Chlorosilanes were Added to the Reactor over a Period of One Hour—MeSiCl₃/PhSiCl₃M (10/5) with Ph₂MeSiCl as the Capping Agent

Toluene (4025.0 gram) and sodium metal (167.30 gram) were loaded into a cylindrical, glass, 6-liter vessel, and then the toluene was brought to reflux using a recirculating bath through the jacket. A nitrogen atmosphere with a slight positive pressure was maintained throughout the process. A dual pitched-blade impeller was used to disperse the molten sodium, and the jacket temperature was maintained at 110° C. A mixture of phenyl methyl dichlorosilane (508.77 gram), methyl trichlorosilane (46.81 gram), and phenyl trichlorosilane (33.12 gram) was introduced to the reactor over a period of 60 minutes using a dip tube positioned above the top of the impeller. This resulted in an exotherm to 113° C. After maintaining the reactor temperature for 30 minutes, diphenylmethylchlorosilane (171.87 gram) was added quickly. After holding the reactor temperature for an additional 1.5 hours, the contents was cooled to 40° C. Methanol (465.99 gram) was added slowly to oxidize the residual sodium. The mixture was held for 30 minutes before being drained from the reactor into 500 mL bottles. This slurry was centrifuged and filtered through a Seitz KS depth filter to separate the salt. The solution was concentrated using a stripper to 1612 gram, which provided a solution containing about 17 percent by weight of solids in toluene. The solution was filtered through a Seitz EK depth filter, and then added slowly to 9098 gram of methanol. This provided a 7:1 ethanol to toluene ratio to re-precipitate the product. The solution was filtered and dried in a vacuum oven, yielding 225 gram of a powdery white solid. The powder was dissolved in toluene (418 gram) to make a 35 percent by weight solution. The solution was filtered through a Seitz EK type depth filter yielding 478 gram of a very clear solution. The solution was added slowly to 3,000 gram of methanol to precipitate out the polymer. Again, this provided a solution with a 7:1 methanol to toluene ratio. The solution was filtered and dried in a vacuum oven. The yield was 184.4 gram of a powdery white solid, or a 52.7 percent yield by weight. Gel permeation chromatography indicated a Mw of 25,600.

### Example 15

### Similar to Example 14 except that the Chlorosilanes were Added to the Reactor over a Period of Two Hours—MeSiCl₃/PhSiCl₃M (10/5) with Ph₂MeSiCi as the Capping Agent

Gel permeation chromatography indicated a Mw of 11,700.

### Example 16

### Similar to Example 5 except that the Chlorosilanes were Added to the Reactor over a Period of 50 Minutes—MeSiCl₃/PhSiCl₃M (10/5) with PhMe₂SiCl as the Capping Agent

Gel permeation chromatography indicated a Mw of 33,500.

### Example 17

### Similar to Example 5 except that the Chlorosilanes were Added to the Reactor over a Period of 140 minutes

Gel permeation chromatography indicated an Mw of 12,100.

The details and results of Examples 1-17 are summarized in Table 1.

TABLE 1
Summary of Examples 1-17

| | Toluene | Sodium | PhMeSiCl₂ | MeSiCl₃ | PhSiCl₃ | Me₃SiCl | PhMe₂SiCl | MeSi(OMe)₃ | MeOH | Acetic Acid | Yield | |
|---|---|---|---|---|---|---|---|---|---|---|---|---|
| Ex. No. | (mole) | (mole) | (mole) | (mole) | (mole) | (mole) | (mole) | (mole) | (mole) | (mole) | (%) | Mw |
| 1 | 16.71 | 2.42 | 0.89 | 0.16 | 0 | 0 | 0 | 0 | 14.53 | 0 | 44.2 | 25,100 |
| 2 | 14.65 | 3.70 | 1.29 | 0.32 | 0 | 0 | 0 | 0 | 22.20 | 0 | 59.4 | 54,000 |
| 3 | 14.65 | 3.7 | 1.29 | 0.32 | 0 | 0 | 0.23 | 0 | 0 | 0 | 54.3 | 46,700 |
| 4 | 43.68 | 7.27 | 2.66 | 0.313 | 0.157 | 0 | 0 | 0 | 14.54 | 0 | 56.7 | 27,000 |
| 5 | 43.68 | 7.27 | 2.66 | 0.313 | 0.157 | 0 | 0.738 | 0 | 14.54 | 0 | 64.4 | 24,100 |
| 6 | 15.86 | 2.35 | 0.86 | 0.152 | 0 | 0 | 0 | 0 | 4.70 | 0.174 | 23.5 | 23,600 |
| 7 | 43.68 | 7.48 | 2.74 | 0.483 | 0 | 0.759 | 0 | 0 | 14.96 | 0 | 25.3 | 18,500 |
| 8 | 43.62 | 7.27 | 2.66 | 0.469 | 0 | 0 | 0 | 0 | 14.53 | 0.538 | 29.2 | 15,800 |
| 9 | 43.68 | 7.48 | 2.74 | 0.483 | 0 | 0 | 0 | 0.759 | 14.96 | 0 | 18.1 | 16,700 |
| 10 | 11.28 | 2.56 | 0.86 | 0.22 | 0 | 0 | 0 | 0 | 15.37 | 0 | 47.6 | 43,800 |
| 11 | 11.28 | 2.56 | 0.86 | 0.22 | 0 | 0 | 0 | 0 | 15.37 | 0 | 49 | 44,200 |
| 12 | 16.71 | 2.56 | 0.86 | 0.22 | 0 | 0 | 0 | 0 | 15.37 | 0 | 24.1 | 25,000 |
| 13 | 16.71 | 2.56 | 0.86 | 0.22 | 0 | 0 | 0 | 0 | 15.37 | 0 | 43.1 | 25,400 |
| 14 | 43.68 | 7.27 | 2.66 * | 0.313 | 0.157 | 0 | 0.738 mole (a) | 0 | 14.0 | 0 | 43 | 25,600 |
| 15 | 43.68 | 7.27 | 2.66 ** | 0.313 | 0.157 | 0 | 0.738 mole (b) | 0 | 14.0 | 0 | 43 | 11,700 |
| 16 | 2353 | 392 | 143 | 17 | 8 | 0 | 40 moles | 0 | 783 | 0 | 50 | 33,500 |
| 17 | 43.68 | 7.27 | 2.66 | 0.313 | 0.157 | 0 | 0.738 | 0 | 14.54 | 0 | 64.4 | 12,100 |

* = Value represents amount obtained where the addition of the chlorsilanes to the reactor was over a period of one hour.
** = Value represents amount obtained where the addition of the chlorsilanes to the reactor was over a period of two hours.
(a) = Value represents amount of Ph₂MeSiCl.
(b) = Value represents amount of Ph₂MeSiCl.

The branched polysilanes of the invention have utility in the normal applications of polysilanes, such as their use as (i) precursors for silicone carbide; (ii) optoelectric materials such as photoresists; (iii) organic photosensitive materials, optical waveguides, and optical memories; (iv) surface protection for glass, ceramics, and plastics; (v) antireflection films; (vi) filter films for optical communication; and in radiation detection.

Other variations may be made in compounds, compositions, and methods described herein without departing from the essential features of the invention. The embodiments of the invention specifically illustrated herein are exemplary only and not intended as limitations on their scope except as defined in the appended claims.

1. A method of preparing branched polysilanes by a Wurtz-type coupling reaction comprising the step of reacting a mixture of a dihalosilane and a trihalosilane, with an alkali metal coupling agent in an organic liquid medium, the reaction mixture being free of tetrahalosilanes, and recovering the branched polysilanes from the reaction mixture.

2. A method according to claim 1 in which the branched polysilane has the formula: 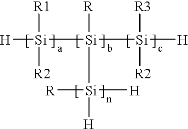
wherein R, R1, R2, and R3 are selected from the group consisting of alkyl groups, aryl groups, cycloalkyl groups, aralkyl groups, and alkaryl groups; and the values of a, b, c, and n, are such as to provide a branched polysilane having a molecular weight in the range of 10,000-50,000.

3. A branched polysilane prepared by the method according to claim 1.

4. A method of preparing capped branched polysilanes by a Wurtz-type coupling reaction comprising the step of reacting a mixture of a dihalosilane and a trihalosilane, with an alkali metal coupling agent in an organic liquid medium, the reaction mixture being free of tetrahalosilanes, adding a capping agent to the reaction mixture, the capping agent being selected from the group consisting of monohalosilanes, monoalkoxysilanes, dialkoxysilanes, and trialkoxysilanes, and recovering capped branched polysilanes from the reaction mixture.

5. A method according to claim 4 in which the capped branched polysilane has the formula: 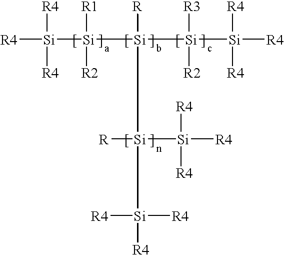
wherein R, R1, R2, and R3 are selected from the group consisting of alkyl groups, aryl groups, cycloalkyl groups, aralkyl groups, and alkaryl groups; and R4 is an alkyl group, an aryl group, a cycloalkyl group, an aralkyl group, an alkaryl group, or an alkoxy group; and the values of a, b, c, and n, are such as to provide a capped branched polysilane having a molecular weight in the range of 10,000-50,000.

6. A capped branched polysilane prepared by the method according to claim 4.
